(19) United States
(12) Patent Application Publication
(10) Pub. No.: US 2010/0070858 A1
(43) Pub. Date: Mar. 18, 2010

(54) Interactive Media System and Method Using Context-Based Avatar Configuration

(75) Inventors: Scott Morris, Decatur, GA (US); Dale Malik, Dunwoody, GA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/209,368

(22) Filed: Sep. 12, 2008

(51) Int. Cl. G06F 3/048; G06F 3/00

(52) U.S. Cl. 715/706; 715/716; 725/39

(57) ABSTRACT

Systems and methods of avatar configuration based on a media stream context are disclosed. In a particular embodiment, a method is disclosed that includes determining context information related to a portion of a media stream. The method also includes selecting configuration settings of an avatar based at least partially on the context information. The avatar is responsive to user input to enable interaction with one or more other users with respect to the media stream. The method further includes sending display data to a user device. The display data includes information to display the avatar with the portion of the media stream.

### FIELD OF THE DISCLOSURE

The present disclosure relates generally to interactive media using context-based avatar configuration.

### BACKGROUND

Television has historically been primarily a one-way communication medium. Content providers have traditionally broadcast media to a plurality of users via satellite, cable or airway broadcasts. More recently, content providers have also provided content via interactive television signals over packet switched networks. However, even interactive systems often function as one-way communication mechanisms to distribute media content to users. Interactions between viewers of the media content are often isolated and separate from the media content that is generated for distribution.

### BRIEF DESCRIPTION OF THE DRAWINGS

FIG. 1 depicts a particular embodiment of an interactive media system;

FIG. 2 depicts a first particular embodiment of a method of interaction with respect to a media stream;

FIG. 3 depicts a second particular embodiment of a method of interaction with respect to a media stream;

FIG. 4 depicts a third particular embodiment of a method of interaction with respect to a media stream;

FIG. 5 depicts a particular embodiment of a display to display a media stream and one or more user avatars;

FIG. 6 depicts a particular embodiment of an avatar configuration screen;

FIG. 7 depicts a particular embodiment of an electronic program guide for use with the interactive media system of FIG. 1; and

FIG. 8 depicts an illustrative embodiment of a general computer system.

### DETAILED DESCRIPTION OF THE DRAWINGS

Methods and systems of avatar configuration based on media stream context are disclosed. In a particular embodiment, the method includes determining context information related to a portion of a media stream. The method includes selecting configuration settings of an avatar based at least partially on the context information. The avatar is responsive to input received from a user to enable interaction with one or more other users with respect to the media stream. The method further includes sending display data to a user device associated with the user, where the display data includes information to display the avatar with the portion of the media stream.

In a particular embodiment, the system includes an avatar configuration module to select avatar configuration settings of an avatar based at least partially on context information related to a portion of a media stream. The system also includes a display module to generate display data including the avatar and including the portion of the media stream, the display module sends the display data to a display device.

In another embodiment, a computer-readable medium is disclosed that includes instructions that, when executed by a processor, cause the processor to determine context information related to a portion of a media stream. The computer-readable medium includes instructions that cause the processor to select avatar configuration settings of an avatar based at least partially on the context information. The computer-readable medium further includes instructions that cause the processor to present the avatar in a display with the portion of the media stream.

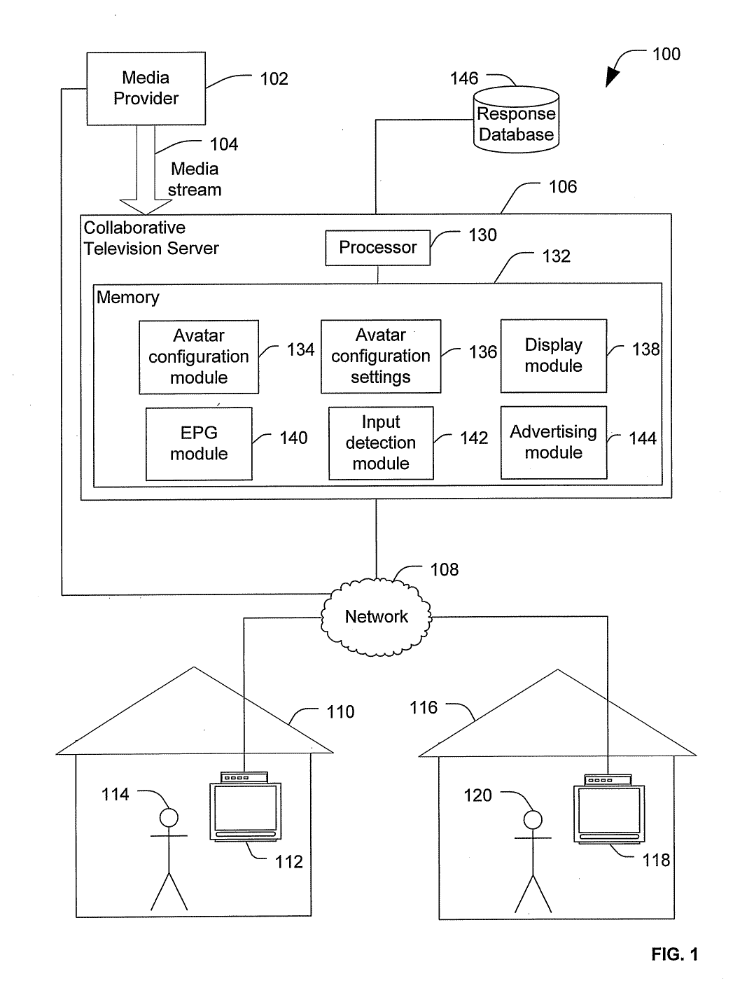

FIG. 1 depicts a first particular embodiment of an interactive media system 100. The system 100 includes an interactive system, such as a system including an interactive collaboration television server 106 or another interactive system, to process a media stream 104. The collaborative television server 106 may enable multiple users, such as representative users 114 and 120, to interact with one another from remote locations with respect to the media stream 104. For example, the users 114 and 120 may comment on the media stream 104 or on content of the media stream 104, or may, converse with one another and present various interactive input via an interactive media system 100. In a particular embodiment, the interactive media system 100 includes a media provider 102 adapted to send the media stream 104, via the collaborative television server 106, to the one or more users 114, 120. The media provider 102 may include a broadcast television provider, an Internet Protocol Television (IPTV) service provider, or any other service provider to, provide real-time media access to multiple users via a network 108.

In a particular embodiment, the media stream 104 includes one or more portions of media, such as television programs, songs, movies, video-on-demand (VoD) content, other media, or any combination thereof. The media stream 104 may be provided to the collaborative television server 106 and/or provided directly to the network 108 for distribution to representative user devices 112, 118 associated with the respective users 114, 120 at remote locations, such as the illustrated user residences 110 and 116. That is, the media provider 102 may send the media stream 104 directly to the user's devices 112, 118 as well as to a collaborative media server 106. Alternatively, the media provider 102 may send the media stream 104 to the collaborative media server 106 which may process the media stream 104 and interactive information received from the users 114, 120 and send a consolidated media stream, that includes the media stream 104 and collaboration information or interactive information from the users. Thus, the media stream 104 may be received by the users 114, 120 from the media provider 102 or from the collaborative television server 106 as part of a consolidated media stream.

In a particular embodiment, the collaborative television server 106 includes a processor 130 and a memory 132 accessible to the processor 130. In a particular embodiment, the memory 132 includes one or more modules or software applications adapted to provide various functions of the collaborative television server 106. For example, the memory 132 may include an avatar configuration module 134, avatar configuration settings 136, a display module 138, an electronic program guide (EPG) module 140, an input detection module 142, and an advertising module 144. Although the modules 134 and 138-144 are depicted as computer instructions that are executable by the processor 130, in other embodiments, the modules 134 and 138-144 may be implemented by hardware, firmware, or software, or any combination thereof.

In a particular embodiment, the avatar configuration module 134 is adapted to select avatar configuration settings 136 for an avatar. The avatar may be responsive to input received from a user to enable interaction with one or more of the users with respect to the media stream 104, and may represent a particular user during interactions with other users with respect to the media stream 104. For example, the avatar may include a simulated human or other simulated entity presented via a display device to provide user directed actions or responses to the media stream 104 or responses to actions of one or more other users.

In a particular embodiment, the avatar configuration module 134 selects the avatar settings based at least partially on context information related to a portion of the media stream 104. The avatar configuration settings 136 may include settings that are selected based on a genre of the media stream 104, a time of day when the media stream 104 is presented, identification information of the one or more users 114, 120, metadata related to the media stream 104, closed-captioning data related to the media stream 104, or other information descriptive of the general context in which the avatar will be used with respect to the media stream 104. The avatar may be selected based on the identification information of the one or more users 114, 120, such that a particular avatar is used with a particular set of users. For example, an individual may have an avatar that is used primarily with a set of friends during interactions with respect to the media stream, and one or more other avatars that are used with other sets of friends or with the general public. The configuration settings 136 may be selected with respect to a genre of the media stream 104. For example, an individual may have one or more genre settings for a specific type of program. To illustrate, a user may define an avatar to have settings to include particular articles of clothing, a particular look or actions of the avatar when a favorite sports team is represented in the media stream 104, such as during a football game of the user's alma mater. In another example, the user may select or define particular avatar configuration settings that are used for mystery movies or for soap operas.

The display module 138 may generate display data that includes the avatar of one or more users and sends the display data to one or more user display devices 112, 118. In a particular embodiment, the display data includes a portion of the media stream 104.

The EPG module 140 is adapted to present an electronic program guide via the display devices 112, 118 to the users 114, 120. The electronic program guide may include context information related to the media stream 104 and adapted to facilitate selection of the particular avatar configuration settings 136 by the respective user 114, 120. For example, the electronic program guide may include information about a particular genre of a portion of the media stream 104, a time of day of the presentation of the media stream 104, or other information about options available to the user regarding avatar configuration settings.

The collaborative television server 106 may also include the input detection module 142. The input detection module 142 is adapted to receive interaction input from the one or more users 114, 120 and to store the interactive input in a response database 146. The interactive input may include text, actions, or input from the users 114, 120 to interact with other users with respect to the media stream 104. For example, in a particular embodiment, a user may select to cheer using his avatar when a favorite team scores during a media presentation of a sports event. In a particular embodiment, the interaction input may be stored along with a time index indicating a time when the interaction input was received. By storing the interactive input with the time index in the response database 146, the collaborative television server 106 is able to regenerate the interaction and correlate the interactive input to a particular portion of the media stream 104 in order to display the interactions and the media stream 104 in response to a user request. For example, the user 114 may desire to watch a replay of a particular play of a previously viewed sporting event. The user may search the response database 146 based on indications of his interactive input indicating a cheer. Based on the search for cheering, the response database 146 may indicate that a particular segment of the media content was being viewed when the cheer was input and may provide the particular portion of media content to the user 114 to review the particular play.

The collaborative television server 106 may also include an advertisement module 144. The advertisement module 144 is adapted to select advertising content to be incorporated into the display data that is provided to the users. The advertising content may be incorporated into a physical appearance of an avatar, into a logo or identifying mark displayed with the avatar, or into a simulated action of the avatar, as illustrative examples. The physical appearance of the avatar may be modified based on the advertising content. To illustrate, in response to an advertisement for beef jerky that includes a camping theme, the avatar may change into a Sasquatch. A logo or identifying mark may be displayed with the avatar, for example, by changing a clothing item simulated on the avatar to include the logo or the identifying mark.

The advertising content selected by the advertising module 144 may be incorporated into an action of the avatar by causing the avatar to perform a particular action or to make a particular statement with respect to the advertising content, such as to sing a jingle associated with a particular product or service. For example, the advertising content may include a statement or an action to be performed by the avatar that is associated with the advertiser's product or service. In a particular embodiment, advertising content may be incorporated into an interactive media presentation with which the avatar may interact. For example, the user may be enabled to interact with the advertising content via the avatar. To illustrate, the interactive media presentation may include an interactive game which is played by the user using the avatar.

During operation, the collaborative television server 106 enables one or more users, such as the first user 114 and the second user 120, to interact with one another and with other users from remote locations, such as a first user residence 110 of the first user 114 and the second user residence 116 of the second user 120. The interactions may include, for example, providing text, automatic actions or selected actions in response to the user input via an avatar. Each user's avatar may include a simulated human or other being (e.g. fictional character) that acts out actions based on input provided by the user. For example, the user's avatar may include a simulated representation of the user or a simulated representation of a favorite character of the user or any other combination of simulated persona based on the configuration settings 136. The configuration settings 136 may be selected based on closed-captioning data received from the media stream 104. For example, a particular trinket held by the avatar, such as a particular beverage container, may be selected in response to recognizing the name of the product represented by the beverage container and the closed-captioning data. To illustrate, when the closed-captioning data includes a mention of the drink, Coca-Cola®, the avatar configuration settings 136 may be changed to simulate the presence of a Coca-Cola® can in the avatar's hand.

The avatar may be responsive to input received from the user to generate actions that are viewable by both the first user 114 and by the second user 120. For example, when the first user 114 provides input indicating a particular statement is made or indicating to perform a particular action by the avatar, the action or statement may be visible to the second user 120 via the collaborative television server 106.

In a particular embodiment, the avatar of the first user 114 and the avatar of the second user 120, and potentially one or more users, may be presented by the collaborative television server 106 with the content of the media stream 104. For example, where the users 114 and 120 are interacting with respect to a sporting event, the sporting event may be presented via the media stream 104 and the interaction of the users 114 and 120 may be presented in the display of a display device 112 or 118 with the content of the media stream. To illustrate, while a particular sporting event is being played, the users may comment on the sporting event, on other events of the day, or may comment on actions and comments received from other users in real-time with respect to the media stream 104.

In a particular embodiment, the collaborative media server 106 stores the interactions of participating users in the response database 146. The response database 146 may store the actions with a time index indicating a particular portion of the media stream 104 that was being viewed while the interaction input was received. By storing the interactions and the response database with the time index, the collaborative media server 106 is able to recreate a portion of the media stream 104 and interactions of the users with respect to the media stream 104 for later review by the users 114, 120 or by one or more other users.

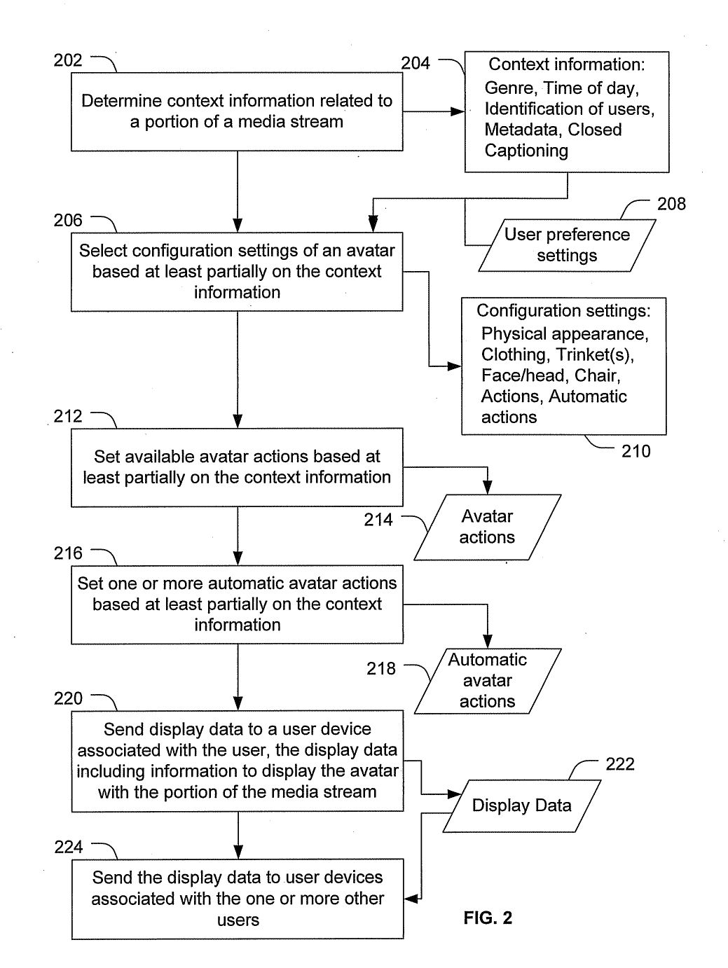

FIG. 2 depicts a first particular embodiment of a method of interaction with respect to a media stream. The method dipicted in FIG. 2 illustrates selecting an avatar based on the media stream. In a particular embodiment, the method includes determining context information related to a portion of the media stream at 202. The media stream may include television programs, songs, movies, video-on-demand (VoD) content, other media, or any combination thereof. The context information 204 may include a genre of the media stream or portion of the media stream, a time of day that the media stream or a portion of media stream is presented, an identification of users interacting via the media stream or a portion of the media stream, metadata related to the media stream or a portion of the media stream, closed-captioning data related to the media stream or a portion of the media stream, other information, or any combination thereof 204.

The method also includes, at 206, selecting configuration settings of an avatar based at least partially on the context information 204. Configuration settings 210 may include, for example, a physical appearance of the avatar, clothing of the avatar, trinkets or other items held by the avatar, a face or head of the avatar, an appearance of the face or head of the avatar, a chair of the avatar, and/or actions or automatic actions performed by the avatar. The configuration settings 210 may also be selected based at least partially on one or more user preference settings 208. For example, the user preference settings 208 may indicate that a particular clothing or appearance of the avatar should be selected for sporting events.

In a particular embodiment, the method includes, at 212, setting available avatar actions 214 based at least partially on the context information 204. The available avatar actions 214 may include avatar actions that express responses of the user related to a portion of the media stream. For example, the avatar actions 214 may include cheers that may be performed by the avatar in response to user input during a sporting event.

The method may also include, at 216, setting one or more automatic avatar actions 218 based at least partially on the context information 204. The one or more automatic avatar actions 218 may include actions that are performed automatically by the avatar in response to the detection of a particular event related to the media stream. For example, the automatic avatar actions may include simulated cheering actions by the avatar when the media stream includes an indication that a particular sports teams has achieved a goal. The indication may include information within the closed-captioning of the media stream that indicates that a goal has been achieved. Alternatively, a state variable may be set with respect to the media stream that indicates that a particular sports teams has achieved the goal or that the event has occurred.

In addition to automatic avatar actions in response to state variables of the media stream, automatic avatar actions may include actions performed by the avatar automatically in response to determining that a particular word or phrase has been detected in closed-captioning text related to the portion of the media stream. To illustrate, the avatar may respond to closed-captioning text that includes the phrase “touchdown” by cheering, but may also respond to closed-captioning text that includes “I love you” by smiling.

As another example, the automatic avatar actions 218 may include performing a specific avatar action when a particular word or phrase of another avatar is presented at the display device. For example, when an avatar associated with a first user says a first part of a cheer, the automatic avatar actions may specify that the user's avatar shall automatically finish the cheer. In yet another example, the automatic avatar actions may include performing a specific avatar action when a particular word, phrase, or action of another avatar is detected but not presented via the display. To illustrate, during an interactive session with respect to a particular media stream, many users may be interacting via an interactive media server. Only some of the users interacting with respect to the media stream may be presented on any particular display. However, when another avatar that is not presented to the display performs a particular action or states a particular word or phrase, the avatar that is displayed may respond by performing an automatic avatar action.

The method also includes sending display data 222 to a user device associated with the user of the avatar at 220. The display data 222 may include information to display the avatar along with a portion of the media stream. The method may also include, at 224, sending the display data 222 to user devices associated with one or more other users at 224. For example, the display data 222 may be sent by the collaborative television server 106 of FIG. 1 to the first user 114 who is associated with the avatar and to the second user 120 that is associated with the second avatar.

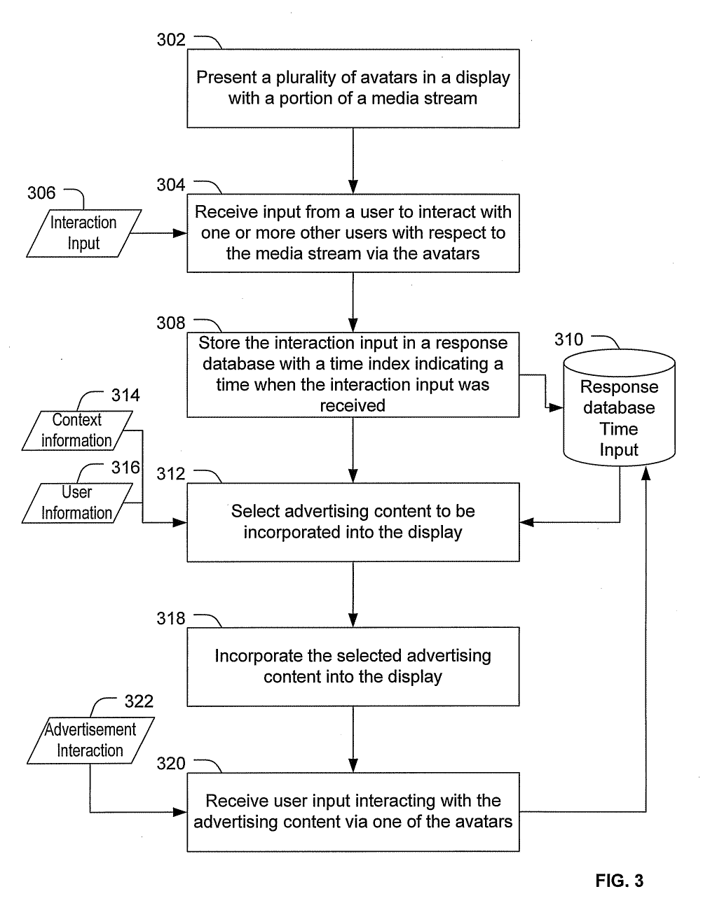

FIG. 3 depicts a second particular embodiment of a method of interaction with respect to a media stream. The method includes presenting a plurality of avatars in a display with a portion of the media stream at 302. The method also includes receiving interaction input 306 from a user to interact with one or more other users with respect to the media stream via the avatars at 304. For example, the interaction input may include an indication of a particular word, phrase or action to be performed by a user's avatar for presentation to other users via the display. The method also includes storing the interaction input in a response database 310 with a time index indicating a time when the interaction input was received at 308.

The method also includes selecting advertisement content to be incorporated into the display at 312. The advertisement content may be selected based at least partially on context information 314 and user information 316. For example, the context information 314 may include information about the content of the media stream, information about the interaction input 306 received from one or more users, a time of day of the presentation of the media stream, or other information relevant to selecting advertising content for presentation to one or more users. The user information 316 may include information about user preferences and settings or other user specific information relevant to advertising.

The method also includes incorporating the selected advertising content into the display at 318. For example, incorporating the selected advertising content may include inserting a portion of media into the media stream or inserting an interactive portion of the media, such as an interactive game into the media stream such that it is playable by one or more of the users via their avatars. The method includes receiving user input interacting with the advertising content via one of the avatars at 320. The advertisement interaction 322 may also be stored at the response database 310 for future reference. For example, the advertisement interaction 322 may be aggregated with other advertisement interaction data to determine a value of future advertising spots in a collaborative television session.

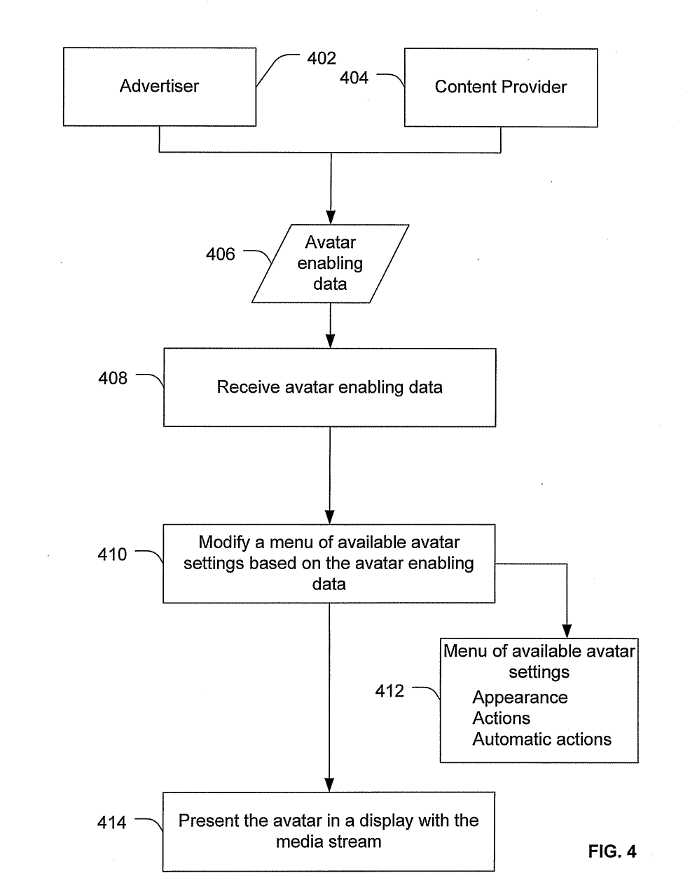

FIG. 4 depicts a third particular embodiment of a method of interaction with respect to a media stream. The method includes, at 408, receiving avatar enabling data 406. The avatar enabling data 406 may include program instructions or data used to configure a particular avatar or to generate a new avatar. In a particular embodiment, the avatar enabling data 406 may be received from an advertiser 402 or from a content provider 404. For example, the avatar enabling data 406 may be related to a particular product or service advertised by the advertiser 402. In another example, the avatar enabling data 406 is related to a specific portion of the media stream provided by the content provider 404. The avatar enabling data 406 may include one or more additional avatar settings to give the avatar a distinctive simulated physical appearance relevant to the portion of the media stream, to provide a distinctive article of simulated clothing relevant to the portion of the media stream to display, a distinctive item related to a setting of the portion of the media stream, or any combination thereof.

To illustrate, the avatar enabling data may include a simulated representation of a product provided by the advertiser or a simulated article of clothing, action, or other avatar-related item relevant to a portion of the media stream provided by the content provider 404. To further illustrate, where the media stream provided by the content provider 404 includes a mystery movie, the avatar enabling data 406 may include data to provide a “Sherlock Holmes” type hat or pipe to the avatar of a user. As another example, where the advertisement product includes a beverage, the avatar enabling data 406 may enable the avatar to hold a simulated beverage container including a logo or other identifying mark related to the beverage.

The method also includes modifying a menu of available avatar settings based on the avatar enabling data at 410. The menu of available avatar settings 412 may include settings related to an appearance of the avatar, actions of the avatar, or automatic actions of the avatar. Settings related to the appearance of the avatar include settings such as the physical appearance of the avatar, such as the head shape, number of limbs, hair, facial features, etc. of the avatar. Settings related to physical appearance of the avatar may also include settings related to clothing, articles held by the avatar (e.g., trinkets), articles worn by the avatar, or articles surrounding the avatar such as a chair or other prop. Settings related to actions of the avatar may include actions that are performed in response to user input.

For example, while interacting with other users via collaborative media systems, such as the system 100 illustrated with respect to FIG. 1, a user may desire to have the user's avatar perform certain actions to simulate an emotional response to the media content. For example, cheering, crying, smiling, or other simulated actions by the user's avatar may illustrate a response to the media content or a response to an input received from other users via their avatars. Such actions may be provided in response to simple keystroke input such as input via a remote control device, input via a motion detection device such as a motion detection enabled remote control device, a user mouse device, or input received via a keyboard or other type of user input device. For example, in response to receiving a particular keystroke, the avatar of the user may be responsive to avatar configuration settings to cause the avatar to cheer.

Settings related to automatic action of the avatar may be implemented using macros that cause the avatar to perform specific actions in response to detecting particular events. For example, the macros may include scripts, instructions, or recorded actions to detect events with respect to the media stream or with respect to actions or words performed by other users via their avatars. To illustrate, a macro may examine closed-captioning data related to the media stream to detect particular words or phrases or states of events and to respond accordingly. For example, where closed-captioning information indicates scary music or creaking doors, the automatic avatar actions may be configured to cause the avatar to cower or shiver.

In another example, the media stream may include event state variables or metadata. For example, during a sporting event, an event state variable may be sent with the media stream indicating when a particular team has scored. The automatic avatar actions may be set via the macro to detect a score via the event state variable and to perform an automatic action response. In another particular example, the macro is set to examine input received from other users and to perform an automatic action in response. For example, where a sporting event is being observed by people cheering for opposing teams, when one avatar cheers, an automatic action may be established to cause the other avatar to boo or cry.

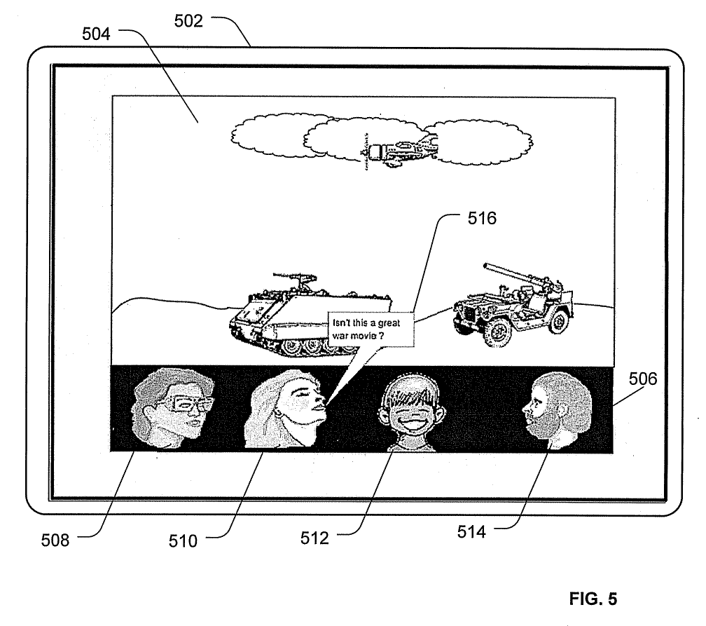

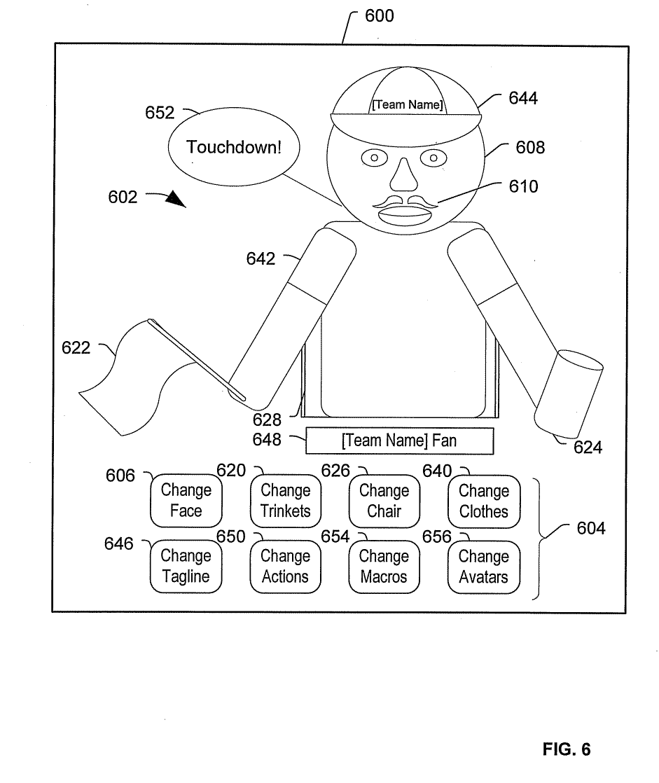

The method also includes presenting the avatar at a display with a portion of the media stream at 414. For example, the avatar generated in response to the avatar enabling data 406 may be presented to a user associated with the avatar to select particular configuration settings and then to reuse the settings by the particular user to interact with one or more other users with respect to the media stream. In an illustrative embodiment, the user may interact with an avatar configuration screen, such as the avatar interaction screen depicted in FIG. 6, to configure the avatar to be used to interact with other users during a television program using a display that shows the television program and also displays avatars of other users, such as the display depicted in FIG. 5.

FIG. 5 depicts a particular embodiment of a display 502 including an area 504 for displaying a media stream and an area 506 for displaying one or more user avatars, such as a first avatar 508, a second avatar 510, a third avatar 512, and a fourth avatar 514. Each of the avatars 508-514 may be associated with a respective user viewing the media stream 504. In a particular embodiment, the users may be remote from one another, such as at user residences at any location throughout the nation or world. The users may simultaneously or substantially simultaneously view the media stream 504 via a media distribution system such as the interactive media system 100 illustrated with respect to FIG. 1. While viewing the media stream, the users may interact via the avatars 508-514 to comment on the media stream, actions or comments of other users or to converse with one another. In a particular embodiment, the user interaction input, such as a comment 516, may be stored in a response database and time indexed to the particular portion of the media stream 504 being viewed when the input was received. The response database may be accessible by one or more of the users or by other users to replay the portion of the media stream and the related interaction input received during the portion of the media stream. Additionally, the one or more other users may be enabled to add additional comments or interactions with respect to the media stream that can be stored in the response database and time indexed to the portion of the media stream being viewed.

FIG. 6 depicts a particular embodiment of an avatar configuration screen 600. The avatar configuration screen 600 includes a representation of an avatar 602 and a menu of available avatar settings 604. The menu of available avatars settings may be used to modify the avatar 602 to configure the avatar 602 for a computer interaction session or to establish a default avatar for a particular type of interaction session. For example, a first avatar may be configured for use while watching a college sporting event of the user's alma mater and a second avatar may be configured for use while watching a movie during a movie club interaction session.

The menu of available avatar settings 604 includes a plurality of user selectable indicators to modify or set a particular avatar setting. For example, the menu of available avatar settings 604 includes a selectable change face indicator 606 that can be selected by the user to change a face or head 608 of the avatar 602 or particular facial features, such as a mustache 610 of the avatar 602. The menu of available avatar settings 604 also includes a selectable change trinkets indicator 620 that can be selected to modify, de-select, or select particular items held by or associated with the avatars, such as a banner or flag 622, or a beverage container 624.

The menu of available avatar settings 604 may also include a selectable item indicator, such as a change chair indicator 626 that can be used to modify, select or de-select an item that is not held by but is otherwise related to the avatar 602, such as a chair 628. The menu of available avatar settings 604 may also include a change clothing selectable indicator 640. The change clothing selectable indicator 640 may allow the user to select, de-select, or reconfigure a simulated article of clothing related to the avatar 602, such as a simulated shirt 642 or simulated hat 644.

The menu of available avatar settings 604 may also include a selectable change tag-line indicator 646. The change tag-line selectable indicator 646 enables the user to input text or to select or de-select a tag line 648 associated with the avatar 602. The menu of available avatar settings 604 may also include a change actions selectable indicator 650. The change action selectable indicator 650 enables the user to configure particular actions that can be performed by the avatar 602 in response to user input. For example, the change action selectable indicator 650 may allow the user to configure particular hot keys or keystroke arrangements that cause the avatar 602 to perform various actions, such as making a statement 652.

The menu of available avatar configuration settings 604 may also include a change macro selectable indicator 654. The change macro selectable indicator 654 enables the user to configure particular automatic actions to be performed by the avatar 602 in response to detection of computer events with respect to a media stream or other avatars. The menu available avatar setting 604 may also include a change avatars selectable indicator 656. The change avatars selectable indicator 656 may enable the user to modify or to change the avatar 602 to another avatar, such as an avatar representing a particular animal, an avatar having a different gender or an avatar having a different or largely different physical appearance. For example, the change avatar selectable indicator 656 may allow the user to select an avatar related to a mystery movie as previously discussed rather than an avatar related to a sporting event, such as the avatar 602 illustrated in FIG. 6.

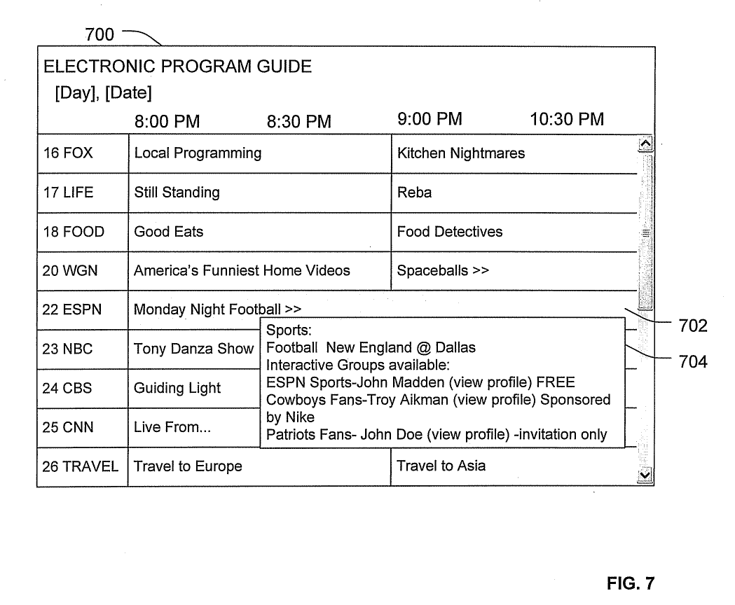

FIG. 7 depicts a first particular embodiment of an electronic program guide 700. The electronic program guide 700 includes a listing of channels and a listing of times in a grid configuration. The grid indicates particular portions of media streams available via multiple channels. For example, the grid arrangement indicates particular television programs available via each channel at particular time slots. The electronic program guide 700 may allow the user to select a particular portion of the media stream 702 such as the highlighted Monday Night Football event 702 to view available options with respect to the media event. For example, as illustrated, after selecting the Monday Night Football event 702, a text box 704 may be displayed indicating that the Monday Night Football event 702 is a sporting event between the particular teams, New England Patriots and Dallas Cowboys. The text box 704 may also include selectable indicators to allow the user to select a particular avatar. For example, the user may select from among avatars related to sporting events, such as a first avatar related to the Dallas Cowboys football team and a second avatar related to the Texas Rangers baseball team. Thus, the avatars available for the user to select may be related to the particular kind of media content of the media stream that is selected, and the user may select among more than one avatar that is related to the particular type of genre of the media content, such as sporting events.

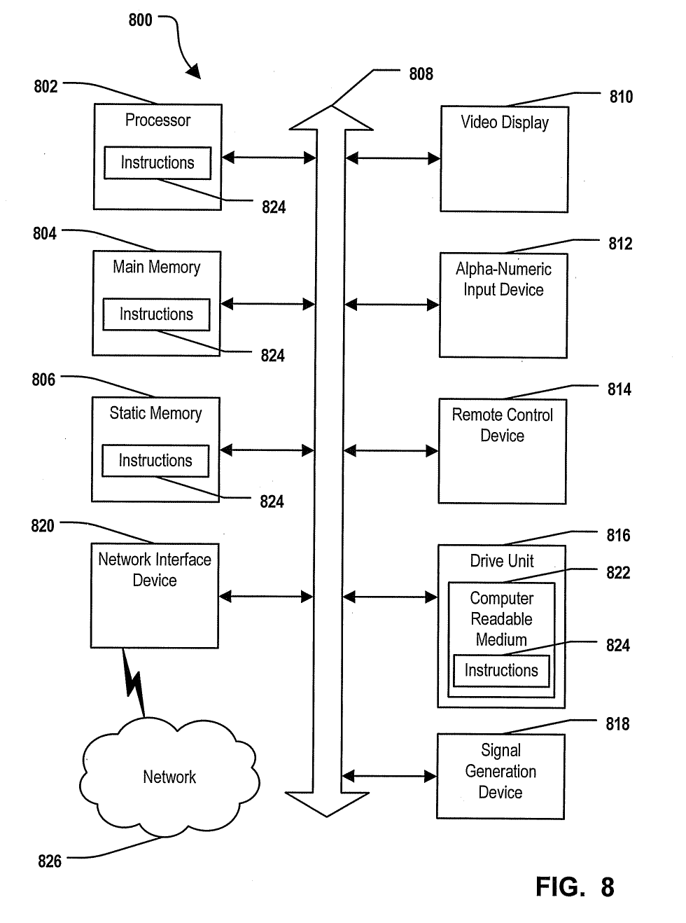

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices. For example, the computer system 800 may include or be included within any one or more of the processors, computers, communication networks, servers, network interface devices, computing devices, set-top box devices, or user devices discussed with reference to FIG. 1.

In a networked deployment, the computer system may operate in the capacity of a server or as a client user computer in a server-client user network environment, or as a peer computer system in a peer-to-peer (or distributed) network environment. The computer system 800, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video, and data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, that can communicate with each other via a bus 808. As shown, the computer system 800 may further include a video display unit 810, such as a liquid crystal display (LCD), a projection television display, a flat panel display, a plasma display, a solid state display, or a cathode ray tube (CRT). Additionally, the computer system 800 may include an input device 812, such as a remote control device, a keyboard, or a cursor control device 814, such as a mouse. The computer system 800 can also include a disk drive unit 816, a signal generation device 818, such as a speaker or a remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered equivalent to a tangible storage medium. Accordingly, the disclosure is considered to include any one or more of a computer-readable medium or other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient standards having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all modifications, enhancements, and other embodiments, that fall within the true spirit and scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
determining context information related to a portion of a media stream;
selecting configuration settings of an avatar based at least partially on the context information, wherein the avatar is responsive to input received from a user to enable interaction with one or more other users with respect to the media stream; and
sending display data to a device associated with the user, wherein the display data includes information to display the avatar with the portion of the media stream.

2. The method of claim 1, wherein the context information includes a genre of the portion of the media stream.

3. The method of claim 1, wherein the context information includes a time of day when the portion of the media stream is to be presented.

4. The method of claim 1, wherein the context information includes identification information related to the one or more other users.

5. The method of claim 1, wherein the context information includes metadata related to the portion of the media stream.

6. The method of claim 1, wherein the context information includes closed captioning data related to the portion of the media stream.

7. The method of claim 1, further comprising sending the display data to user devices associated with the one or more other users.

8. The method of claim 7, wherein the display data further comprises information to display a plurality of avatars wherein each of the plurality of avatar represents the user or one of the one or more other users.

9. The method of claim 1, wherein the configuration settings define a simulated physical appearance of the avatar.

10. The method of claim 1, wherein the configuration settings define simulated clothing of the avatar.

11. The method of claim 1, wherein the portion of the media stream comprises a television program.

12. The method of claim 1, further comprising setting available avatar actions based at least partially on the context information.

13. The method of claim 12, wherein the avatar actions express responses of the user related to the portion of the media stream.

14. The method of claim 1, further comprising setting one or more automatic avatar actions, wherein the automatic avatar actions include one or more actions automatically performed by the avatar in response to detection of an event related to the media stream.

15. The method of claim 14, wherein the automatic avatar actions include simulated cheering actions by the avatar.

16. The method of claim 14, wherein the automatic avatar actions include performing a specified avatar action when a particular word or phrase is detected in close captioning text related to the portion of the media stream.

17. The method of claim 16, wherein the automatic avatar actions include performing a specified avatar action when a particular word, phrase or action of another avatar presented in the display is detected.

18. The method of claim 1, wherein the portion of the media stream includes a program scheduled for transmission via a television transmission system.

19. A system, comprising:
an avatar configuration module to select avatar configuration settings of an avatar based at least partially on context information related to a portion of a media stream, wherein the avatar is responsive to user input to enable interaction with one or more other users with respect to the media stream; and
a display module to generate display data including the avatar and the portion of the media stream and to send the display data to a display device.

20. The system of claim 19, wherein the media stream comprises an Internet Protocol Television (IPTV) channel and the portion of the media stream comprises a television program.

21. The system of claim 19, further comprising an input detection module to receive interaction input from the user or from the one or more other users and to store the interaction input in a response database.

22. The system of claim 21, wherein the interaction input from the user or from the one or more other users is stored in the response database with a time index indicating when the interaction input was received.

23. The system of claim 19, further comprising an advertising module to select advertising content to be incorporated into the display data.

24. The system of claim 23, wherein the advertising content is incorporated into a simulated physical appearance of the avatar.

25. The system of claim 23, wherein the advertising content includes a logo or identifying mark displayed with the avatar.

26. The system of claim 23, wherein the advertising content is incorporated into simulated actions of the avatar.

27. The system of claim 26, wherein the advertising content includes a statement or action performed by the avatar that is associated with an advertised product or service.

28. The system of claim 23, wherein the advertising content is incorporated into the display data via an interactive media presentation, wherein the user is enabled to interact with the advertising content via the avatar.

29. The system of claim 28, wherein the interactive media presentation includes an interactive game played using the avatar.

30. The system of claim 19, further comprising an electronic program guide module, wherein the electronic program guide module generates an electronic program guide display including the context information.

31. A computer-readable medium, comprising:
instructions that, when executed by a processor, cause the processor to determine context information related to a portion of a media stream;
instructions that, when executed by the processor, cause the processor to select avatar configuration settings of an avatar based at least partially on the context information, wherein the avatar is responsive to user input enabling interaction with one or more other users with respect to the media stream; and
instructions that, when executed by the processor, cause the processor to present the avatar in a display with the portion of the media stream.

32. The computer-readable medium of claim 31, wherein the configuration settings are further selected based at least partially on user preference settings.

33. The computer-readable medium of claim 31, wherein the avatar configuration settings are selected from a menu of available avatar settings.

34. The computer-readable medium of claim 33, further comprising instructions that, when executed by the processor, cause the processor to receive avatar enabling data and to modify the menu of available avatar settings based on the avatar enabling data.

35. The computer-readable medium of claim 33, wherein the avatar enabling data is received from an advertiser, and wherein the menu of available avatar settings is modified to add one or more additional avatar settings related to a product or service of the advertiser.

36. The computer-readable medium of claim 33, wherein the avatar enabling data is received from a provider of the media stream, and wherein the menu of available avatar settings is modified to add one or more additional avatar settings associated with the portion of the media stream.

37. The computer-readable medium of claim 36, wherein the one or more additional avatar settings give the avatar a distinctive simulated physical appearance relevant to the portion of the media stream.

38. The computer-readable medium of claim 36, wherein the one or more additional avatar settings provide a distinctive article of simulated clothing related to the portion of the media stream.
